(19) United States
(12) Patent Application Publication
(10) Pub. No.: US 2024/0016689 A1
(43) Pub. Date: Jan. 18, 2024

(54) WEARABLE MODULE AND MOTION ASSISTANCE DEVICE COMPRISING SAME

(71) Applicant: Samsung Electronics Co., Ltd., Suwon-si (KR)

(72) Inventors: Minhyung LEE, Suwon-si (KR); Younbaek LEE, Suwon-si (KR); Segon ROH, Suwon-si (KR); Byungjune CHOI, Suwon-si (KR)

(21) Appl. No.: 18/475,651

(22) Filed: Sep. 27, 2023

Related U.S. Application Data
(63) Continuation of application No. PCT/KR2022/002896, filed on Mar. 2, 2022.

(30) Foreign Application Priority Data
Apr. 1, 2021 (KR) 10-2021-0042548
Jan. 3, 2022 (KR) 10-2022-0000524

(51) Int. Cl. A61H 1/02

(52) U.S. Cl. CPC A61H 1/0262; A61H 2201/1642

(57) ABSTRACT

A wearable module for supporting a part of a user's body for use with a motion assistance apparatus, may include: a cover which comprises a cover base capable of supporting a part of the user's body, a first guide formed at the cover base, and a second guide protruding from the cover base and provided in parallel to the first guide; and a fastening frame which comprises a fastening body, a pair of fastening protruding parts protruding from the fastening body, and a fastening rod connecting, directly or indirectly, the pair of fastening protruding parts and slidable between the first guide and the second guide. Various other embodiments are possible.

### CROSS-REFERENCE TO RELATED APPLICATIONS

This application is a continuation application of International Application No. PCT/KR2022/002896 designating the United States, filed on Mar. 2, 2022, in the Korean Intellectual Property Receiving Office and claiming priority to Korean Patent Application No. 10-2021-0042548, filed on Apr. 1, 2021, and to Korean Patent Application No. 10-2022-0000524, filed on Jan. 3, 2022, in the Korean Intellectual Property Office, the disclosures of which are incorporated by reference herein in their entireties.

### BACKGROUND

### Technical Field

Various example embodiments relate to a wearable module and a motion assistance device including same.

### Description of Related Art

A motion assistance device refers to a mechanism or a device that helps a patient, who cannot walk on his own due to various diseases, accidents, and the like, to perform exercises for rehabilitation treatment; and/or may refer to an apparatus for helping a user to exercise. With the recent intensifying aging societies, a growing number of people experience inconvenience in exercising or have difficulty in normal exercising due to malfunctioning joint issues, and there is increasing interest in motion assistance devices. A motion assistance device is worn on the body of a user to assist the user to exercise, for example, by providing a necessary muscular strength that allows the user to walk so that the user may exercise normally.

In general, users wearing a motion assistance device may be people with physical disabilities, and/or people who desire to exercise. The process of putting on a motion assistance device itself may be difficult. There is a need for technology that allows users with physical disabilities to wear a motion assistance device alone without the help of others.

The above description has been possessed or acquired by the inventor(s) in the course of conceiving the present disclosure and is not necessarily an art publicly known before the present application is filed.

### SUMMARY

According to various example embodiments, a wearable module may be a wearable module that supports a part of a body of a user and includes a cover including a cover base configured to support a part of the body of the user, a first guide formed on, directly or indirectly, the cover base, and a second guide protruding from the cover base and provided parallel to the first guide and a fastening frame including a fastening body, a pair of fastening protrusions protruding from the fastening body, and a fastening rod connecting, directly or indirectly, the pair of fastening protrusions and slidable between the first guide and the second guide.

In various example embodiments, the fastening body may rotate with one degree of freedom around the fastening rod.

In various example embodiments, each of the pair of fastening protrusions may be positioned opposite to each other with respect to the second guide.

In various example embodiments, the fastening body, the pair of fastening protrusions, and the fastening rod may surround the second guide.

In various example embodiments, the fastening rod may have a circular cross-section cut in a direction perpendicular to a longitudinal direction of the fastening rod.

In various example embodiments, the cover may further include a guide cover protruding from the second guide in a direction toward the first guide and configured to cover the fastening rod.

In various example embodiments, a distance between the guide cover and the first guide may be less than a diameter of the fastening rod.

In various example embodiments, a thickness of each of the pair of fastening protrusions may be less than a distance between the guide cover and the first guide.

In various example embodiments, the cover may further include a stopper positioned on a moving path of the fastening rod and interfering with the fastening rod.

In various example embodiments, the stopper may protrude from one of the cover base and the first guide.

In various example embodiments, the stopper may be provided at a position spaced apart from the second guide in a longitudinal direction of the second guide.

In various example embodiments, the wearable module may further include a strap connected, directly or indirectly, to the cover and the fastening frame and surrounding at least a part of the body of the user.

In various example embodiments, the strap may include a strap body, a first strap arm extending from one end of the strap body and passing through the fastening frame and attached to, directly or indirectly, an outer surface of the strap body, and a second strap arm extending from the other end of the strap body and passing through the cover and attached to, directly or indirectly, an inner surface of the strap body.

In various example embodiments, the second strap arm may be provided covered by the strap body.

According to various example embodiments, a motion assistance device may include a main frame, an actuator disposed on the main frame, a driving frame rotatable by receiving power from the actuator, and a wearable module connected, directly or indirectly, to the driving frame, wherein the wearable module includes a cover including a cover base connected to the driving frame, a first guide formed in a longitudinal direction on the cover base, and a second guide protruding from the cover base and provided parallel to the first guide and a fastening frame including a fastening body, a pair of fastening protrusions protruding from the fastening body, and a fastening rod connecting, directly or indirectly, the pair of fastening protrusions and slidable between the first guide and the second guide.

### BRIEF DESCRIPTION OF DRAWINGS

The above and other aspects, features, and advantages of certain example embodiments of the present disclosure will be more apparent from the following detailed description, taken in conjunction with the accompanying drawings, in which:

FIG. 1 is a front view of a motion assistance device according to an example embodiment.

FIG. 2 is a side view of the motion assistance device according to an example embodiment.

FIG. 3 is a front view of a wearable module according to an example embodiment.

FIG. 4 is a cross-sectional view of the wearable module according to an example embodiment.

FIG. 5 is a cross-sectional view of the wearable module according to an example embodiment.

FIG. 6 is a front view illustrating that a fastening frame slides along a cover according to an example embodiment.

FIG. 7 is a cross-sectional view of the wearable module according to an example embodiment.

FIG. 8 is a cross-sectional view schematically illustrating a pair of wearable modules according to an example embodiment.

FIG. 9 is a diagram schematically illustrating that the wearable module of the motion assistance device is worn on the upper arm of a user, according to an example embodiment.

### DETAILED DESCRIPTION

The following detailed structural or functional description is provided as an example only and various alterations and modifications may be made to examples. Accordingly, the embodiments are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a “first” component may be referred to as a “second” component, and similarly, the “second” component may be referred to as the “first” component.

It should be noted that if it is described that one component is “connected”, “coupled”, or “joined” to another component, at least a third component(s) may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

The same name may be used to describe an element included in the embodiments described above and an element having a common function. Unless otherwise mentioned, the descriptions of the embodiments may be applicable to the following embodiments and thus, duplicated descriptions will be omitted for conciseness.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, the examples will be described in detail with reference to the accompanying drawings. When describing the embodiments with reference to the accompanying drawings, like reference numerals refer to like elements and any repeated description related thereto will be omitted.

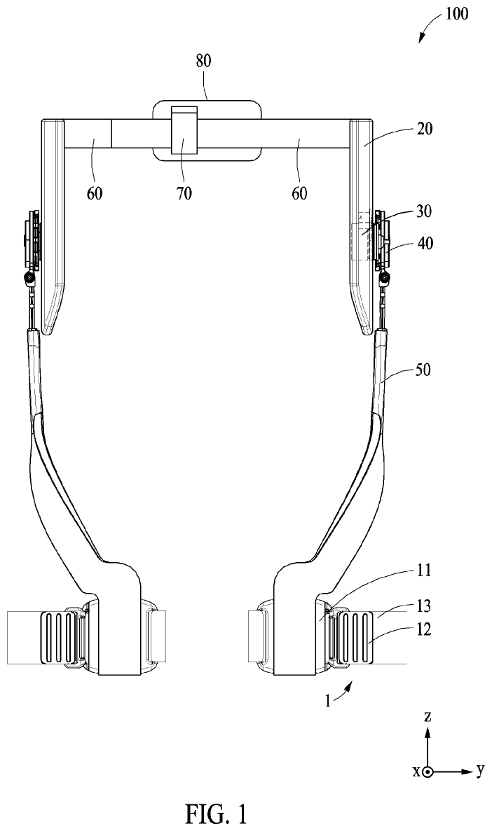

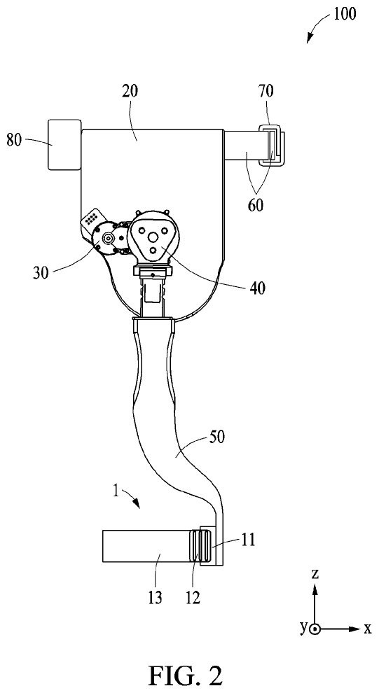

FIG. 1 is a front view of a motion assistance device according to an embodiment and FIG. 2 is a side view of the motion assistance device according to an embodiment.

Referring to FIGS. 1 and 2, a motion assistance device 100 may be worn on a user and assist a motion of the user. The user may be, for example, a human, an animal, or a robot, but is not limited thereto. In addition, although FIG. 1 illustrates an example in which the motion assistance device 100 assists a motion of the thigh of the user, the motion assistance device 100 may assist a motion of another portion of the upper body, for example, the hand, the upper arm, and the lower arm of the user, or a motion of another portion of the lower body, for example, the foot, and the calf of the user. That is, the motion assistance device 100 may assist a motion of a portion of the user. Hereinafter, an example in which the motion assistance device 100 assists a motion of the thigh of the user is described.

In an embodiment, the motion assistance device 100 may include a main body 80, a pair of main frames 20, a pair of belts 60, an auxiliary belt 70 connected, directly or indirectly, to one of the pair of belts 60, an actuator 30, a joint member 40, a driving frame 50, and a wearable module 1. The wearable module 1 may include a cover 11, a fastening frame 12, and a strap 13.

In an embodiment, the motion assistance device 100 may support each of the proximal portion and the distal portion the user, and may assist a relative motion between the proximal portion and the distal portion. Components worn on the proximal portion of the user of the motion assistance device 100 may be referred to as a ‘proximal wearing portion’, and components worn on the distal portion of the user may be referred to as a ‘distal wearing portion’. For example, the main body 80, the pair of main frames 20, the pair of belts 60, and the auxiliary belt 70 of the components of the motion assistance device 100 may correspond to the proximal wearing portion, and the wearable module 1 may correspond to the distal wearing portion. For example, the proximal wearing portion may be worn on the waist or the pelvis of the user and the distal wearing portion may be worn on the thigh or the calf of the user. It should be noted that positions in which the proximal wearing portion and the distal wearing portion are worn are not limited thereto. For example, the proximal wearing portion may be worn on the torso or the shoulder of the user and the distal wearing portion may be worn on the upper arm or the lower arm of the user.

In an embodiment, the main body 80 may accommodate a controller (not shown) to control the actuator 30 and a power supply portion (not shown) to supply power to the actuator 30 therein. For example, the main body 80 may be disposed on a back of the user based on a state in which the motion assistance device 100 is worn on the body of the user.

In an embodiment, the pair of main frames 20 may be connected, directly or indirectly, to the main body 80. The main frame 20 may support a portion of the body of the user. The main frame 20 may contact at least a part of an outer surface of the user. The main frame 20 may have a shape surrounding the outer surface of the user. The main frame 20 may be curved in a shape corresponding to a contact portion of the user. That is, the main frame 20 may include a curved surface in contact with the user. For example, the main frame 20 may support the waist of the user.

In an embodiment, the pair of belts 60 may be connected to the pair of main frames 20, respectively. The pair of belts 60 may maintain a shape extending forward (an x direction) before the user wears the motion assistance device 100 and may not prevent the user from entering inside of the pair of main frames 20. On the other hand, in a state in which the user enters inside of the pair of main frames 20, the pair of belts 60 may be deformed and as shown in the drawings, may enclose a front portion of the user. The main body 80, the pair of main frames 20, and the pair of belts 60 may entirely surround the circumference of the user.

In an embodiment, the pair of auxiliary belts 70 may fix the pair of belts 60 to each other while the pair of belts 60 overlap each other. For example, one of the pair of belts 60 may enclose the other belt with the pair of auxiliary belts 70.

In an embodiment, the actuator 30 may provide power to be transmitted to the joint member 40. The actuator 30 may include a motor that generates power by receiving voltage or current from the power supply portion. For example, the actuator may be disposed in a lateral direction of the joint member 40. That is, a rotation axis of the actuator 30 and a rotation axis of the joint member 40 may be disposed to be spaced apart from each other. In this case, a height protruding from the user may decrease, in comparison to a case in which the actuator 30 and the joint member 40 share a rotation axis. On the other hand, unlike the drawings, the actuator 30 may be disposed to be spaced apart from the joint member 40. In this case, a power transmission module to transmit power from the actuator 30 to the joint member 40 may be provided. The power transmission module may be a rotary body, such as a gear, or a longitudinal member, such as a wire, a cable, a string, a rubber band, a spring, a belt, or a chain. However, in an embodiment, a position and a power transmission structure of the actuator 30 are not limited.

In an embodiment, the joint member 40 may receive power from the actuator 30 to assist a motion of the joint portion of the user. The joint member 40 may be disposed at a position corresponding to the joint portion of the user. The joint member 40 may be disposed on one side of the main frame 20. One side of the joint member 40 may be connected, directly or indirectly, to the actuator 30 and the other side thereof may be connected to the driving frame 50. The joint member 40 may be rotated by the power received from the actuator 30. An encoder to measure a rotation angle of the joint member 40 may be disposed on one side of the joint member 40.

In an embodiment, the driving frame 50 may transmit assistance force to assist a motion of a portion of the user. Here, the assistance force may be understood as force acting in the same direction as a direction of a motion of a portion of the user. That is, the assistance force may be understood as force obtained by excluding force acted in a direction intersecting the direction of the motion of the portion of the user from among force acted to the portion of the user. One end portion of the driving frame 50 may be connected to the joint member 40 and may be rotated. The other end portion of the driving frame 50 may be connected to the cover 11 and may transmit assistance force to a portion of the user. For example, the driving frame 50 may push or pull the thigh of the user. The driving frame 50 may extend in a longitudinal direction of the thigh of the user. The driving frame 50 may be bent to surround at least a part of the circumference of the thigh of the user. For example, an upper portion of the driving frame 50 may cover a portion of the body of the user facing a side (a +y direction or a −y direction) and a lower portion of the driving frame 50 may cover a portion of the body of the user facing a front (a +x direction).

In an embodiment, the cover 11 may act assistance force on a portion of the user. For example, the cover 11 may be disposed on one side of the thigh of the user to push or pull the thigh of the user. The cover 11 may be disposed on a front surface of the thigh of the user. The cover 11 may be disposed in a circumferential direction of the thigh of the user. The cover 11 may extend to both sides around the other end portion of the driving frame 50. The cover 11 may include a curved surface corresponding to the thigh of the user.

In an embodiment, the fastening frame 12 may be connected, directly or indirectly, to one side of the cover 11. For example, the fastening frame 12 may be disposed to surround at least a part of the circumference of the thigh of the user to prevent or reduce a chance of the thigh of the user from separating from the driving frame 50.

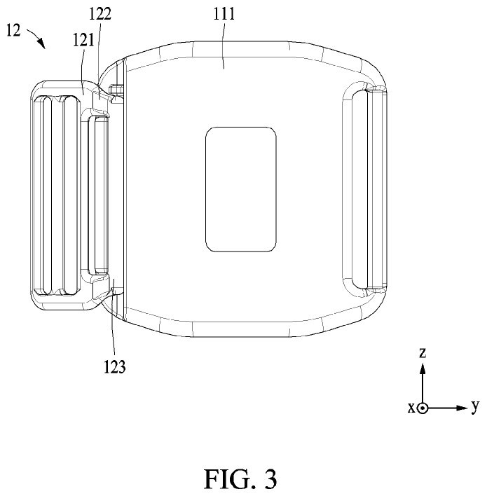

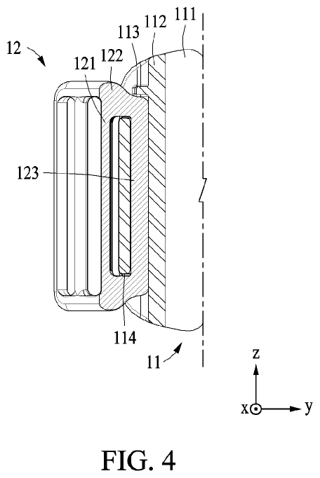

FIG. 3 is a front view of a wearable module according to an embodiment, FIG. 4 is a cross-sectional view of the wearable module according to an embodiment, and FIG. is a cross-sectional view of the wearable module according to an embodiment.

Referring to FIGS. 3 to 5, a wearable module (e.g., the wearable module 1 of FIG. 1) may support at least a part of the body of the user. In FIGS. 3 to 5, it should be noted that a strap (e.g., the strap 13 of FIG. 1) is not shown. The wearable module may include the cover 11, the fastening frame 12, and a strap (e.g., the strap 13 of FIG. 1).

The strap may be connected, directly or indirectly, to the cover 11 and the fastening frame 12. For example, one end of the strap may be connected, directly or indirectly, to the cover 11 and the other end of the strap may be connected, directly or indirectly, to the fastening frame 12. The user may wear the wearable module on the body without fastening the fastening frame 12 to the cover 11. For example, the user may fasten the fastening frame 12 to the cover 11 while placing the cover 11 close to the body of the user. For example, the user may fasten the fastening frame 12 to the cover 11 after placing the cover 11 on the front of the thigh. In a state in which the fastening frame 12 is fastened to the cover 11, the strap may surround the thigh.

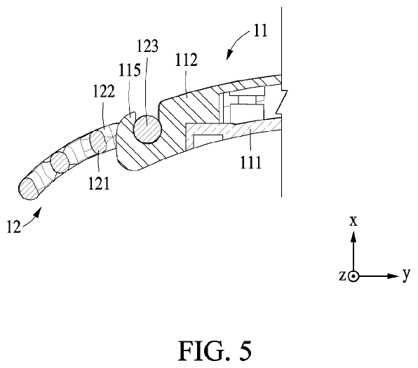

The cover 11 may act assistance force on at least a part of the body of the user. For example, the cover 11 may be disposed on one side of the thigh of the user. The cover 11 may be disposed in the circumferential direction of the thigh of the user. Referring to FIG. 5, the cover 11 may include a curved surface corresponding to the thigh of the user. The cover 11 may include a cover base 111, a first guide 112, a stopper 113, a second guide 114, and a guide cover 115.

The cover base 111 may support a part of the body of the user. For example, the cover base 111 may have a plate shape having a curved surface. For example, the inner surface of the cover base 111 may contact the thigh. A portion for supporting the strap may be provided at the right end portion of the cover base 111 and a portion for supporting the fastening frame 12 may be provided at the left end portion of the cover base 111. Herein, it should be noted that the right side refers to the +y side and the left side refers to the −y side. For example, a hole through which the strap passes may be provided on the left side of the cover base 111. For example, an end portion of the strap may pass through the hole and may adhere to a surface of the other portion of the strap.

The first guide 112 may be formed on, directly or indirectly, the cover base 111. For example, the first guide 112 may protrude from the cover base 111. For example, the first guide 112 may be formed at the left end portion of the cover base 111. The first guide 112 may be a longitudinal member. The longitudinal direction of the first guide 112 may be formed in the vertical direction. Herein, it should be noted that the upper side refers to the +z side and the lower side refers to the −z side.

The stopper 113 may be positioned on a moving path of a fastening rod 123. The stopper 113 may interfere with the fastening rod 123. For example, the stopper 113 may set a moving range of the fastening rod 123. The stopper 113 may assist the fastening frame 12 to slide excessively and completely through the cover 11 and not separate from cover 11. For example, the stopper 113 may protrude from one of the cover base 111 and the first guide 112.

The stopper 113 may be provided at a position spaced apart from the second guide 114 in the longitudinal direction of the second guide 114. A space opening in the −y direction may be provided between the stopper 113 and the second guide 114. One fastening protrusion 122 of the pair of fastening protrusions 122 may be provided between the stopper 113 and the second guide 114.

The second guide 114 may be provided generally parallel to the first guide 112. For example, the second guide 114 may protrude from the cover base 111. For example, the second guide 114 may be formed at the left end portion of the cover base 111. For example, the second guide 114 may be provided at a position spaced apart from the first guide 112 in the left direction. The second guide 114 may be a longitudinal member. The longitudinal direction of the second guide 114 may be formed in the vertical direction.

A space for guiding sliding of the fastening frame 12 may be provided between the first guide 112 and the second guide 114. For example, each of the first guide 112, the second guide 114, and the cover base 111 may be provided contacting with the fastening frame 12.

The guide cover 115 may protrude from the second guide 114 in a direction toward the first guide 112 and cover the fastening rod 123. The guide cover 115 may protrude from the upper end portion of the second guide 114 toward the first guide 112. The guide cover 115 may prevent or reduce a chance of the fastening frame 12 from separating forward while the fastening frame 12 is fastened to the cover 11. Herein, it should be noted that forward refers to the +x direction.

The cover base 111, the first guide 112, the stopper 113, and the second guide 114 may enclose the fastening rod 123 of the fastening frame 12. The cover base 111, the first guide 112, the stopper 113, and the second guide 114 may assist the fastening rod 123 to slide with one degree of freedom. For example, each of the cover base 111, the first guide 112, the stopper 113, and the second guide 114 may contact a surface of the fastening rod 123.

The fastening frame 12 may be fastened to the cover 11. For example, the fastening frame 12 may be fastened to the cover 11 by moving upward. In another example, although not shown, the stopper 113 may be positioned below the second guide 114 and the fastening frame 12 may be fastened to the cover 11 by moving downward. After sliding until the fastening frame 12 reaches a set position, the fastening frame 12 may rotate around the z-axis and be switched to a completely fastened state. For example, the fastening frame 12 may rotate around the fastening rod 123. In a state in which the fastening frame 12 is completely fastened, the movement of the fastening frame 12 in the x-axis direction, the y-axis direction, or the z-axis direction may be prevented or reduced by the cover 11. The fastening frame 12 may include a fastening body 121, the pair of fastening protrusions 122, and the fastening rod 123.

The fastening body 121 may support a strap (e.g., the strap 13 of FIG. 1). The fastening body 121 may include, for example, at least one hole for accommodating the strap. The fastening body 121 may rotate with one degree of freedom around the fastening rod 123. For example, the fastening body 121 may rotate with one degree of freedom around the z-axis. For example, the fastening body 121 may slide with one degree of freedom in a state before the fastening frame 12 is completely fastened to the cover 11 and may rotate with one degree of freedom in a completely fastened state.

The pair of fastening protrusions 122 may protrude from the fastening body 121. In a state in which the fastening frame 12 is completely fastened to the cover 11, the pair of fastening protrusions 122 may be positioned opposite to each other with respect to the second guide 114. One of the pair of fastening protrusions 122 may prevent or reduce a chance of the fastening frame 12 from moving upward and the other one may prevent or reduce a chance of the fastening frame 12 from moving downward.

The fastening rod 123 may slide between the first guide 112 and the second guide 114. The fastening body 121, the pair of fastening protrusions 122, and the fastening rod 123 may enclose the second guide 114. For example, the fastening body 121, the pair of fastening protrusions 122, and the fastening rod 123 may have an approximately rectangular ring shape.

The fastening rod 123 may have a circular cross-section cut in a direction perpendicular to the longitudinal direction of the fastening rod 123. Each of the cover base 111, the first guide 112, the stopper 113, and the second guide 114 may contact a surface of the fastening rod 123. The cover base 111, the first guide 112, the stopper 113, and the second guide 114 may have a cylindrical hollow portion for accommodating the fastening rod 123. The fastening rod 123 may rotate with one degree of freedom inside of the cover base 111, the first guide 112, the stopper 113, and the second guide 114.

Referring to FIG. 5, a distance between the guide cover 115 and the first guide 112 may be less than the diameter of the fastening rod 123. According to this shape, the fastening rod 123 may be prevented from unintentionally separating in the +x direction.

The thickness of each of the pair of fastening protrusions 122 may be less than a distance between the guide cover 115 and the first guide 112. According to this shape, the pair of fastening protrusions 122 may slide between the guide cover 115 and the first guide 112.

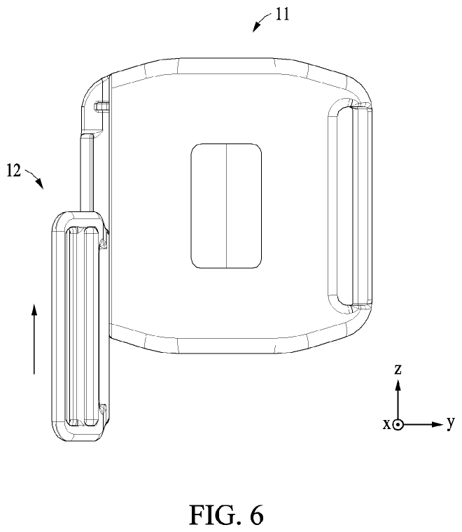

FIG. 6 is a front view illustrating that a fastening frame slides along a cover according to an embodiment.

Referring to FIG. 6, the fastening frame 12 may be fastened to the cover 11. For example, the fastening frame 12 may slide along the cover 11 in an upright state in the x-axis direction. For example, FIG. 6 illustrates an upright state of the fastening frame 12 in the x-axis direction. The fastening frame 12 may slide in the z-axis direction in an upright state in the x-axis direction.

After moving until the fastening frame 12 contacts the stopper of the cover 11, the fastening frame 12 may be rotated around the z-axis. The user may easily fasten the fastening frame 12 to the cover 11 by sliding the fastening frame 12. FIG. 2 illustrates a state in which the fastening of the fastening frame 12 is completed. For example, the user may separate the fastening frame 12 from the cover 11 by sliding the fastening frame 12 in an upright state in the x-axis direction.

Although FIG. 6 illustrates a structure in which the fastening frame 12 may be fastened by sliding upward along the cover 11 and separated by sliding downward, the structure is not limited thereto. For example, the fastening frame 12 may be fastened by sliding downward along the cover 11 and separated by sliding upward.

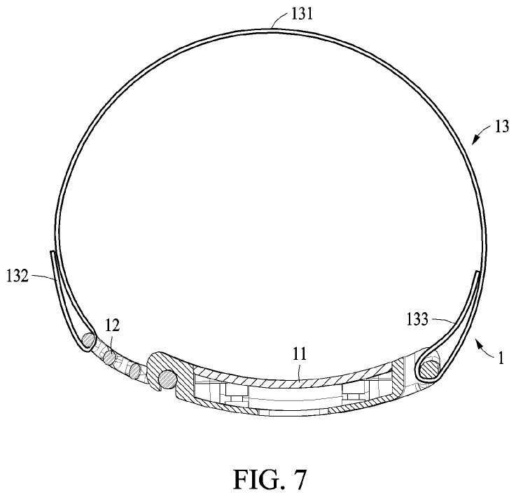

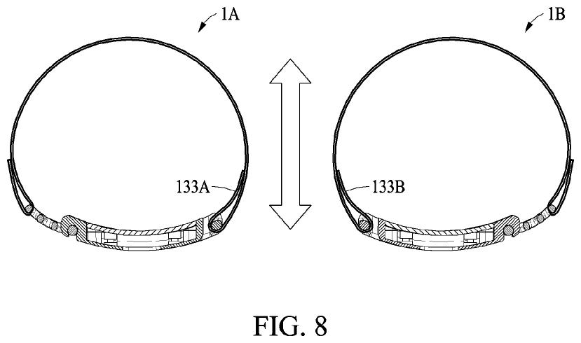

FIG. 7 is a cross-sectional view of the wearable module according to an embodiment and FIG. 8 is a cross-sectional view schematically illustrating a pair of wearable modules according to an embodiment.

Referring to FIGS. 7 and 8, the wearable module 1 may include the cover 11, the fastening frame 12, and the strap 13. The strap 13 may include a strap body 131 surrounding at least a part of the body of the user, a first strap arm 132 extending from one end of the strap body 131, passing through the fastening frame 12, and attached to, directly or indirectly, an outer surface of the strap body 131, and a second strap arm 133 extending from the other end of the strap body 131, passing through the cover 11, and attached to, directly or indirectly, the inner surface of the strap body 131.

The first strap arm 132 may adhere to the outer surface of the strap body 131. For example, Velcro tape may be disposed on a surface facing the outer surface of the strap body 131 of the first strap arm 132.

The second strap arm 133 may adhere to the inner surface of the strap body 131. For example, Velcro tape may be disposed on a surface facing the inner surface of the strap body 131 of the second strap arm 133. The second strap arm 133 may be provided covered by the strap body 131. The second strap arm 133 may be covered by the strap body 131. For example, the second strap arm 133 may be covered by the strap body 131. That is, the second strap arm 133 may be hidden by the strap body 131 when viewed from the outside.

Through the second strap arm 133, the size of the strap 13 may be adjusted. The user may adjust the size itself of the strap 13 through the second strap arm 133 and attach or detach the strap 13 to or from the body through the first strap arm 132. According to this structure, it is possible to adjust various body sizes to fit each user with one strap 13 without the need to separately manufacture the strap 13 having various sizes.

Referring to FIG. 8, in a state in which a pair of wearable modules 1A and 1B is worn on the thigh of the user, when the user walks, the pair of wearable modules 1A and 1B may move relatively to each other in the direction of the arrow. Here, each of a first strap arm 133A of the first wearable module 1A and a second strap arm 133B of the second wearable module 1B may be hidden by the strap body to not interfere with each other. According to this structure, unintentional loosening may be prevented or reduced due to unintentional collision of the first strap arm 133A of the first wearable module 1A and the second strap arm 133B of the second wearable module 1B while walking.

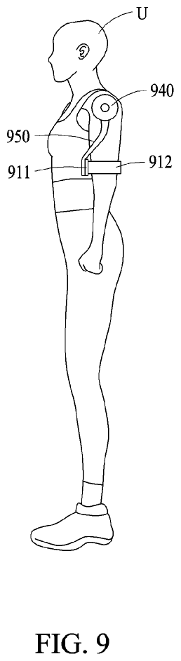

FIG. 9 is a diagram schematically illustrating that the wearable module of the motion assistance device is worn on the upper arm of a \user, according to an embodiment.

Referring to FIG. 9, a wearable module of a motion assistance device may be worn on the upper arm of a user U. For example, a joint member 940 of the motion assistance device may be provided near the shoulder of the user U and a driving frame 950 may be connected to the joint member 940 and disposed along the upper arm of the user U.

In an embodiment, a cover 911 may be connected to an end portion of the driving frame 950 to support a portion of the upper arm of the user. A strap 912 may be connected to the cover 911. The strap 912 may be connected to the cover 911 to support the other parts of the upper arm. An elastic layer (not shown) may be provided inside of the cover 911 and the strap 912. The joint member 940 may rotate the driving frame 950 by receiving power from an actuator (not shown).

Although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

Therefore, other implementations, other embodiments, and/or equivalents of the claims are within the scope of the following claims.

1. A wearable module for supporting a part of a body of a user, the wearable module comprising:
a cover comprising a cover base configured to support a part of the body of the user, a first guide formed on the cover base, and a second guide protruding from at least the cover base and provided substantially parallel to the first guide; and
a fastening frame comprising a fastening body, a pair of fastening protrusions protruding from the fastening body, and a fastening rod connecting the pair of fastening protrusions and configured to be slidable between at least the first guide and the second guide.

2. The wearable module of claim 1, wherein the fastening body is rotatable with one degree of freedom around the fastening rod.

3. The wearable module of claim 1, wherein each of the pair of fastening protrusions is positioned opposite to each other with respect to the second guide.

4. The wearable module of claim 1, wherein the fastening body, the pair of fastening protrusions, and the fastening rod at least partially surround the second guide.

5. The wearable module of claim 1, wherein the fastening rod comprises a circular cross-section cut in a direction perpendicular to a longitudinal direction of the fastening rod.

6. The wearable module of claim 1, wherein the cover further comprises a guide cover protruding from the second guide in a direction toward the first guide and configured to cover the fastening rod.

7. The wearable module of claim 6, wherein a distance between the guide cover and the first guide is less than a diameter of the fastening rod.

8. The wearable module of claim 6, wherein a thickness of each of the pair of fastening protrusions is less than a distance between the guide cover and the first guide.

9. The wearable module of claim 1, wherein the cover further comprises a stopper positioned on a moving path of the fastening rod and configured for interfering with the fastening rod.

10. The wearable module of claim 9, wherein the stopper protrudes from one of the cover base and the first guide.

11. The wearable module of claim 9, wherein the stopper is provided at a position spaced apart from the second guide in a longitudinal direction of the second guide.

12. The wearable module of claim 1, further comprising:
a strap connected to the cover and the fastening frame and configured for at least partially surrounding at least a part of the body of the user.

13. The wearable module of claim 12, wherein the strap comprises:
a strap body;
a first strap arm extending from one end of the strap body and passing through the fastening frame and attached to an outer surface of the strap body; and
a second strap arm extending from the other end of the strap body and passing through the cover and attached to an inner surface of the strap body.

14. The wearable module of claim 13, wherein the second strap arm is provided covered by the strap body.

15. A wearable module for supporting a part of a body of a user of a wearable motion assistance apparatus, the wearable module comprising:
a cover comprising a cover base configured to support a leg and/or arm of the user, a first guide formed on the cover base, and a second guide protruding from at least the cover base and provided parallel to the first guide; and
a fastening frame comprising a fastening body, a pair of fastening protrusions protruding from the fastening body, and a fastening rod connecting the pair of fastening protrusions and configured to be slidable between at least the first guide and the second guide.

16. A wearable motion assistance apparatus, comprising:
a belt,
an actuator,
a driving frame, and
a wearable module, wherein the driving frame is provided between at least the actuator and the wearable module,
wherein the wearable modules comprises:
a cover comprising a cover base configured to support a leg and/or arm of the user, a first guide formed on the cover base, and a second guide protruding from at least the cover base and provided substantially parallel to the first guide; and
a fastening frame comprising a fastening body, a pair of fastening protrusions protruding from the fastening body, and a fastening rod connecting the pair of fastening protrusions and configured to be slidable between at least the first guide and the second guide.
